(19) United States
(12) Patent Application Publication
(10) Pub. No.: US 2008/0046416 A1
(43) Pub. Date: Feb. 21, 2008

(54) Dynamic program support links

(75) Inventors: Mai-Ian Tomsen Bukovec, Seattle, WA (US); Jeanine E. Spence, Seattle, WA (US); Eric D. Kidd, Redmond, WA (US); Gary J. Purchase, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/506,422

(22) Filed: Aug. 18, 2006

(51) Int. Cl. G06F 17/30

(52) U.S. Cl. 707/4

(57) ABSTRACT

Described is a technology by which support information (e.g., help and/or other information) related to a computer program is automatically and dynamically searched with respect to a task of that program, with the results of the search aggregated for output in relation to the program. For example, the search may be based on active context data of the task (e.g., such as error data and the current operating environment), so that the support information that is located matches what is likely relevant. User preference data and default data may be used to narrow the search to specific sites, such as community forums that have been deemed to be valuable. Other input used to generate the query or queries may include historical and/or statistical data, and/or explicit user input.

### BACKGROUND

Information technology (IT) is an important part of commercial businesses and other enterprises, such as educational institutions and the like. When an IT administrator performs administrative tasks, such as to install software on a computer, one or more various problems can arise, typically as a result of configuration and settings issues. As a result, the IT administrator often needs assistance to resolve the problems. Additionally, the administrator may want to learn more about the installed software's functionality or learn about different ways to complete a task using the software.

The established way to obtain support (e.g., assistance or other information) for a software program is to access the software's end user help. In the past, help information shipped only with the software, such as in a software program's help file, however today the help information (e.g., file content) is often available over the Internet. Moreover, with the Internet, an IT administrator has additional Web-based resources for support beyond the help file. For example, the IT administrator can go to on-line discussion groups to review previous posts and responses, post a question, review community forum content for published articles of interest, and/or access other technical sources, such as the Microsoft® Knowledge Base, which can be searched for articles containing support information. In fact, many IT administrators in smaller companies who have little time for research depend heavily on Web resources to quickly find answers to questions and research how to perform administrative tasks.

However, with so much information available, locating an appropriate resource for a given issue is somewhat of a hit-or-miss operation. Although a simple solution and/or other ideal piece of information may exist for an issue, to find it the administrator may need to identify the issue using the proper terminology, locate an appropriate information source, submit a proper query for that source, and so on. Thus, finding the desired resource or set of resources is a manual, ad hoc administrative task that is unsystematic, often providing undesirable and unpredictable results that lead to time-consuming reattempts.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which support information related to a program is automatically searched with respect to a task of that program. The results of the search are aggregated for output in relation to the program. For example, the search may be based on a task name, active context data of the task (e.g., such as error data) and user preference data; the output may be in the form of content and/or a link, and a source, and the results may be ranked, grouped and/or filtered. A user also may rate results according to perceived effectiveness, to help add to the effectiveness of future automatic filtering and the like by the system.

In an example implementation, a search system receives input related to a program task, and a query generator generates at least one query based on the input and searches for results via the at least one query. An aggregator aggregates the results for output in relation to the program. The search system, query generator and aggregator may be incorporated into a dynamic support links mechanism. In this example, a task engine may provide context data corresponding to at least some of the input related to the program task, a data store may provide historical and/or statistical data corresponding to at least some of the input related to the program task. The query generator may generate the query based upon user preference data corresponding to a site to be searched.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose computing environment including a network into which various aspects of the present invention may be incorporated.

FIG. 2 is a block diagram representation of a dynamic support links mechanism for providing software support.

FIG. 3 is a block diagram representing example input to a search mechanism and output via an aggregator of a dynamic support links mechanism.

FIG. 4 is a representation of an example flow diagram in which support is provided in response to a user error in a program.

FIG. 5 is a representation of an example flow diagram in which support is provided in response to a user request for information.

FIG. 6 is a representation of an example flow diagram in which support is provided in response to a user seeking information regarding a task.

FIG. 7 shows an illustrative example of a general-purpose computing environment including a computer into which various aspects of the present invention may be incorporated.

### DETAILED DESCRIPTION

### Dynamic Program Support Links

Various aspects of the technology described herein are generally directed towards a mechanism that in general consistently and systematically provides a bridge between dynamic content on the web (e.g., online discussion groups, community forum content, knowledge bases like the Microsoft® Knowledge Base and so on), and an installed software installation and experience on a computing device such as a network server. In one example implementation, the mechanism may be provided as part of a suite of server programs, but as will be understood, can be part of another suite of application programs such as Microsoft® Office, can be part of an individual application or operating system program, or can be a standalone program that works to provide dynamic links to content on behalf of some other program, e.g., via an interface between the programs. As such, although the examples herein are described in the context of a mechanism that assists in network administration, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and/or administration in general.

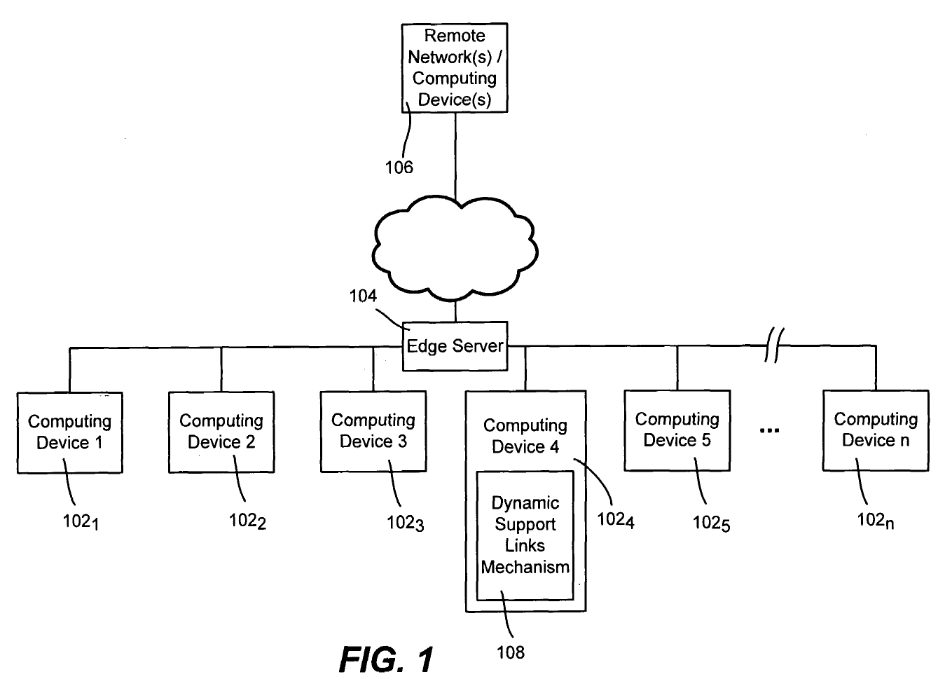

FIG. 1 shows an example network arrangement for a hypothetical enterprise, in which a number of computing devices 102₁-102ₙ are coupled via an edge server 104 to other remote networks and/or computing devices 106. Although not shown in FIG. 1, it is understood that various other networking components may be present, e.g., routers, switches, hubs, modems, and hardware-based firewalls.

In the example shown, one of the computing devices (e.g., 102₄) is represented as containing a dynamic program support links mechanism 108, which as described below, provides an administrator with a systematic way to locate software support information such as relevant help, information and other assistance. Note that there may be various instances of the dynamic program support links mechanism 108, e.g., the administrator may be able to run the mechanism from any suitable computing device on the network, or even on a remote device 106. Further, as also described below, the dynamic program support links mechanism 108 may be configured as various components, some or all of which may be distributed and/or replicated across multiple computing devices.

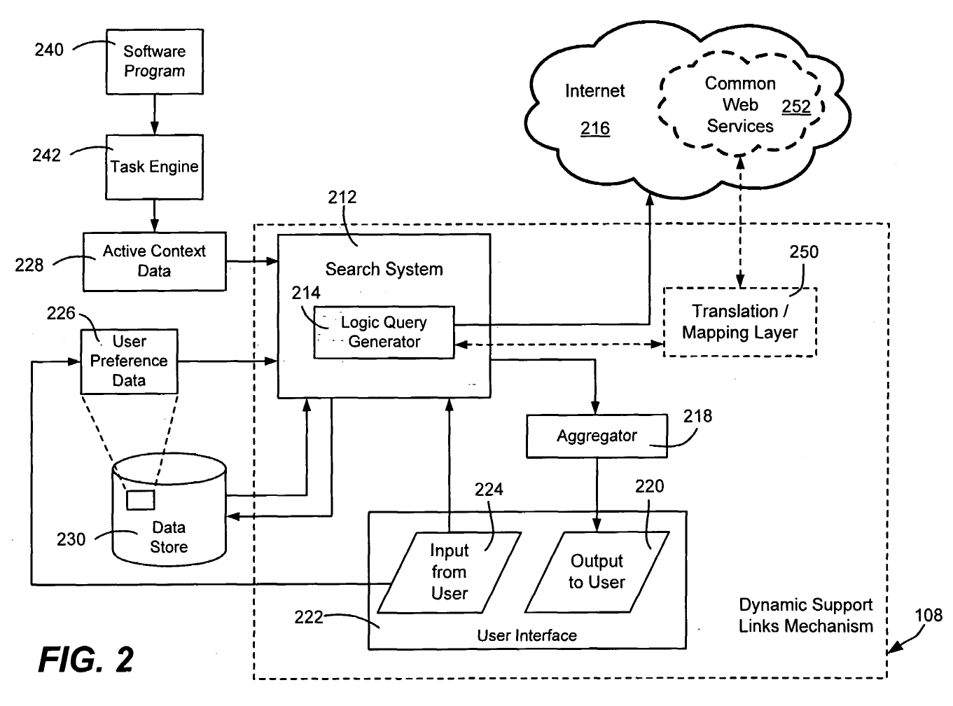

FIG. 2 provides a conceptual representation of components that may comprise a suitable dynamic program support links mechanism 108. In general, a search system 212 including a logic query generator 214 receives input from a number of possible sources, and submits appropriate queries to sources on the Internet 216 that are deemed likely to supply the desired results; (a local source such as a help file, as well as an intranet source such as a company database also may be searched, and are implicitly represented by the cloud surrounding the Internet 216). The search system 212 provides the results to an aggregator 218, which aggregates the results into user output 220, such as via a user interface 222. The results may comprise content and/or one or more links, and a source of each content/link. Other ways of outputting the aggregated results include writing to a file, printing a report, sending an email message or other notification, and so forth. The user may save content and/or a link, e.g., by interacting with the aggregated output 220, and the user may add a source to the user preference data.

In general, the input or inputs from which the search system 212 generates the query includes user input 224, user preference data 226, active context data 228 and/or other data from a data store 230 (which may be local or remote). Such other data may include historical data and/or statistical data (e.g., based on past queries), and/or possibly data downloaded from a remote source. For example, a program developer may discover that many users are experiencing a common problem, and may provide a link to a solution for that problem that is beyond what the user could easily find via the help file. Note that the user preference data may be in its own data location, but may be part of the data store 230.

User preference data 226 generally refers to providing the user of the mechanism 108 to modify the default configuration, including where to look online for support content. For example, if the user has one or more preferred locations for content, the user can add those web sites, e.g., into a preference page hosted as part of the mechanism 108. This preference page will be referenced to search the user-specified website content for related information. Site usage patterns of the administrator may also be used to deduce preferences. The user also may set preferences on the limits of results. For example, if the user wants to see the top twenty results instead of all results, the system will return (or at least only display) the topmost relevant twenty results. This allows the user to better control the amount of detail returned at part of the search.

When a search is complete, the user may also provide effectiveness rating data corresponding to the results of the search. This effectiveness rating data may be maintained as part of the user preference data to help locate relevant results in future searches. For example, a profile may be associated with the user that comprises preferences and ratings that help define and filter search results.

In addition to containing the set of one or more preferred websites that the user wants searched, the user preference data 226 may possibly contain other information, such as the username and password data for websites that require credentials, e.g., subscription sites; (note that this is optional, as many users prefer to manually type in password information). Also, although not specifically shown in FIG. 2, the user preference data 226 may be coupled to the aggregator 218 such as to weight the order in which results are output to the user according to a user-provided ranking or the like. For example, a user may wish to see a certain site's results ahead of any others, even before results that otherwise may be deemed more relevant by the aggregator 218.

The active context data 228 typically refers to information about the operating environment of a software program 240 (and/or program's task), such as any of the version, operating system version, hardware, other programs and the like, and/or the state of the program/task for which support is being sought. A task engine 242 associated with (e.g., integrated into or otherwise coupled to) the software program 240 provides context related to the task that is (or was) in the process of execution just before or when the user requested support, e.g., by invoking the dynamic program support links mechanism 108. Active context data 228 may include an identifier of the application or workload involved in the task, the type of task (e.g., configuration, maintenance, and so forth) and the current action (e.g., changing a disk quota). Other types of active context data 228 may include one or more error codes that were returned upon task completion, or other debugging-type information.

Thus, the search system 212 may take one or more keywords for a search via user input 224, active context data (e.g., the error message of an error, or the task context), user preference data 226 and other data (represented by the data store 230). For example, a query can be built using common language queries, keywords that map to unique identifiers or context information such as task names, error codes and environment variables, e.g., with the mappings maintained in the data store 230, behavior logs such as regarding a task's relationship to one or more other tasks, and explicit user input.

With this information, the logic query generator 214 runs a search across a specified set of web sources. Also note that FIG. 2 shows a representation of an optional (as indicated by the dashed box) translation/mapping layer 250. This will allow the dynamic support links mechanism 108 to be extended to work with web services 252, including possibly having the web services 252 perform some of the search and/or aggregation functionality. For example, the translation/mapping layer 250 may take one type of query format and convert it to one or more other types of query format to match specific web service and/or website requirements.

With respect to aggregation of the output results, ranking, grouping and/or filtering of the results may be performed in various ways. For example, likely relevance (e.g., based on matched keywords, direct match of an errorcode and so forth) may be used as one ranking criterion, as may trustworthiness of the source (e.g., according to user preferences, the program developer's rankings and so forth). The administrator's patterns of usage may be another important ranking criterion; the administrator may provide feedback in this regard, including for local pattern usage and/or to the source of the result, or the usage may be deduced, e.g., based on time spent reviewing an article, whether the administrator used a result for a more focused search, and so forth. The date of the resource may be another criterion, as for example, an old article that predates the current operating system's version may seem relevant but may actually be obsolete in view of by a more recent article. Any other ranking criteria that is locally or remotely available to the aggregator may be used, e.g., popularity, previous feedback, and so forth.

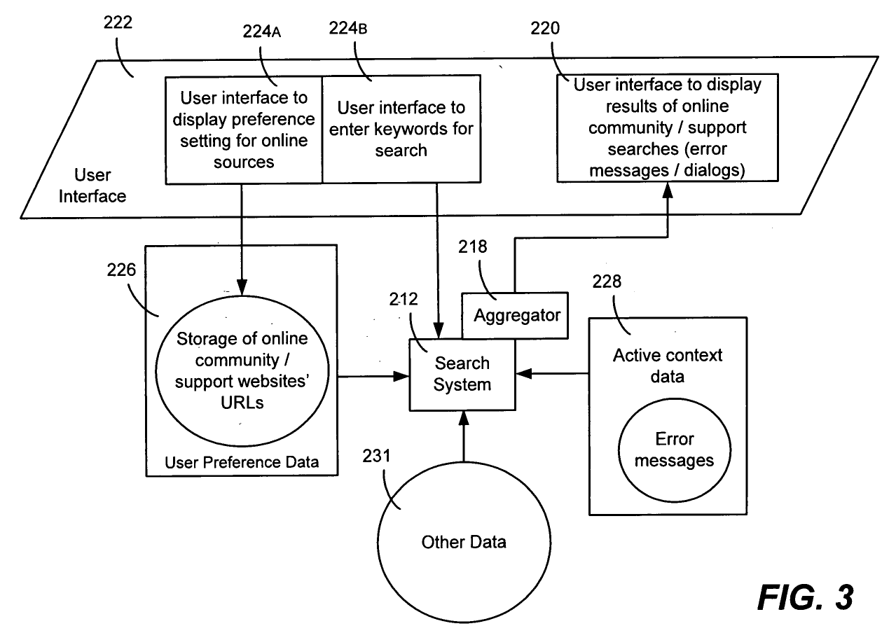

FIG. 3 shows a more particular example of the components of the mechanism 108, including with some example input and output information. In FIG. 3, the query generator 214 is shown as receiving one or more keywords 224B (possibly connected via logical operators) from the user interface 222. Further, the user interface 222 provides a way for the user to provide (and possibly display) online source preference input 224A, which is stored (e.g., as URLs) in the user preference data 226. As described above, the user interface 222 thus allows an administrator/user to modify the default search locations to search for online content.

The search system 212, using one or more queries generated by the query generator 214 (FIG. 2), automatically scans the Internet for related content. The scan may be performed independent of any user action. The aggregator 218 processes and returns the content (or links thereto), such as in the form of “Recommended Reading,” e.g., ranked based on criteria such as including the prior usage patterns of the administrator. The aggregated results, such as including the URLs and the source information, may be returned as the output 20, such as in the form of error messages, in a dialog or a pop-up window, or in some other way.

Turning to an explanation of the invoking of the dynamic program support link mechanism, in one implementation, support is offered from a number of locations in a software usage experience. These may include providing links to support sites such as online discussion forums that contain posts about an error when displaying an indication of that error. Also, in the context of task completion, links that directly relate to the task or tasks are displayed. Further, links to a variety of Web-based sources are displayed in response to specific search queries.

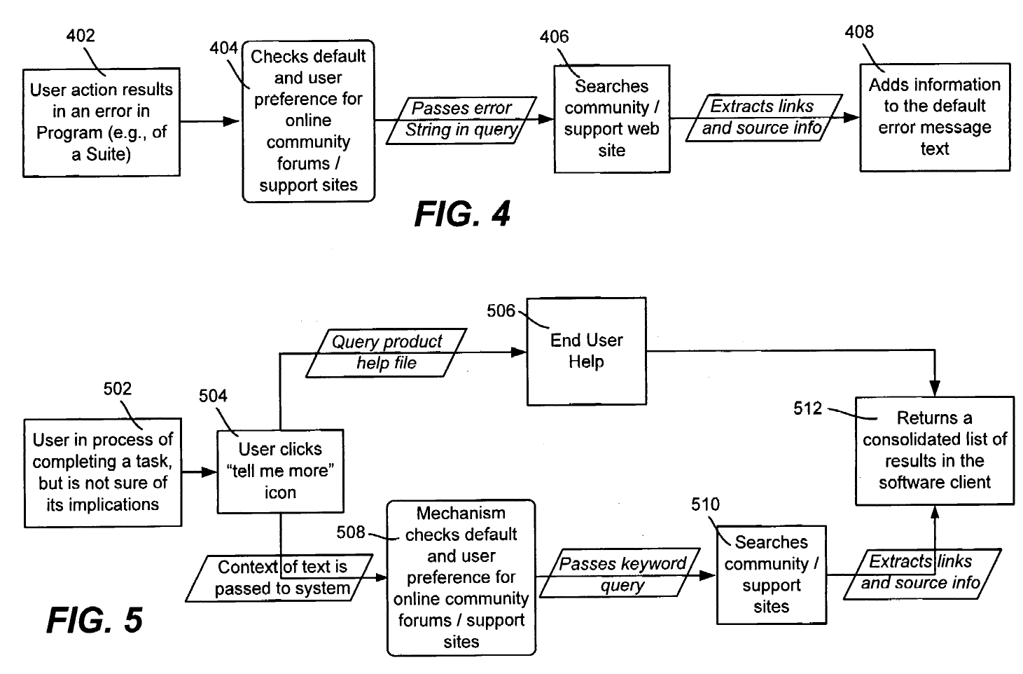

FIG. 4 shows a flow diagram in which a user action results in an error (block 402). Block 404 represents the program support links mechanism 108 checking default and user preferences for online community forums and/or support sites. The error string or other code is passed as a parameter for the query, which is then used to search the sites (block 406). From the results, the aggregator then extracts links and source information, and possibly other information, and outputs it to the user, such as by adding information to the default error message's text (block 408). In this manner, in response to an error being displayed, links to support sites and/or community online discussion forums that contain posts about that error are aggregated and output.

FIG. 5 shows a flow diagram in which a user is requesting information regarding a task (blocks 502 and 504). Block 506 represents querying the program's help file, while blocks 508 and 510 represent the mechanism 108 checking the default and user preferences for online community forums and/or support sites, and searching the sites with keywords or the like based on the current context. Block 512 represents aggregating the results from the help file and the query, and outputs it to the user, such as by merging links and source information into the help file text output, or providing a separate list. Note that in an alternative to blocks 502 and 504, task completion may directly or indirectly trigger the search and display of links that directly relate to that task.

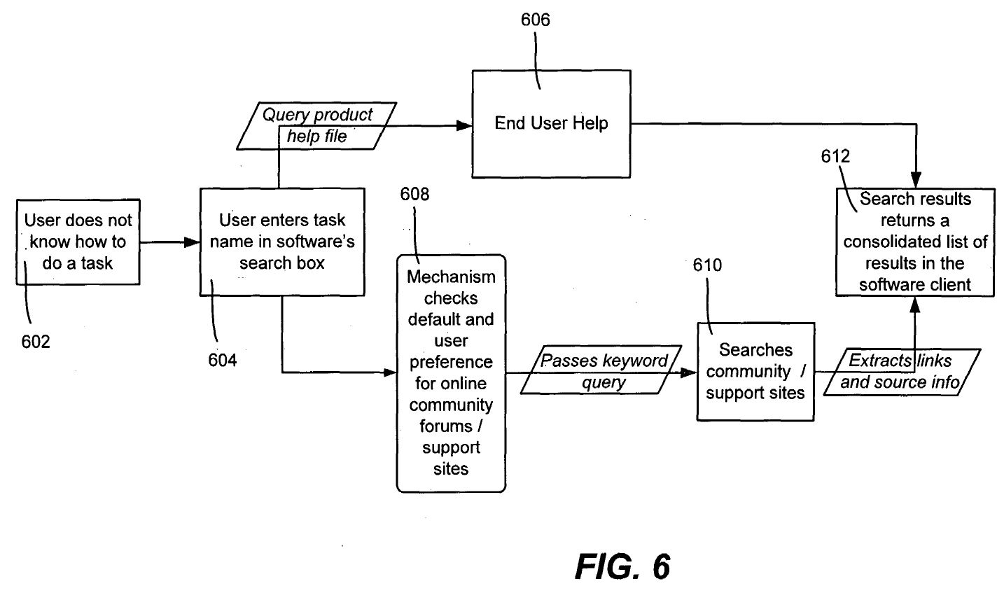

FIG. 6 shows another alternative, in which the user wants to perform a task, but does not know how (block 602), or otherwise seeks information on a task. Note that unlike FIG. 5, there may not be any current task context information at this time, and thus the user instead identifies the task (block 604). As can be readily appreciated, the rest of the process is similar to that of FIG. 5, e.g., block 606 represents querying the program's help file, while blocks 608 and 610 represent the mechanism 108 checking the default and user preferences for online community forums and/or support sites, and searching the sites with keywords or the like (this time based on the task name). Block 612 represents aggregating the results from the help file and the query, and outputs it to the user, such as by merging links and source information into the help file text output, or providing a separate list.

As can be readily appreciated, dynamic program support links thus are highly valuable to administrators seeking support such as assistance and/or other information about a software program. By using the context of a task when available to drive the dynamic query, more desirable results are quickly and automatically found, and complementary information provided. Further, the user can supply preference data to customize where to look for the content. Still further, the aggregation and display of query results providing a meaningful and useful output to the user.

### Exemplary Operating Environment

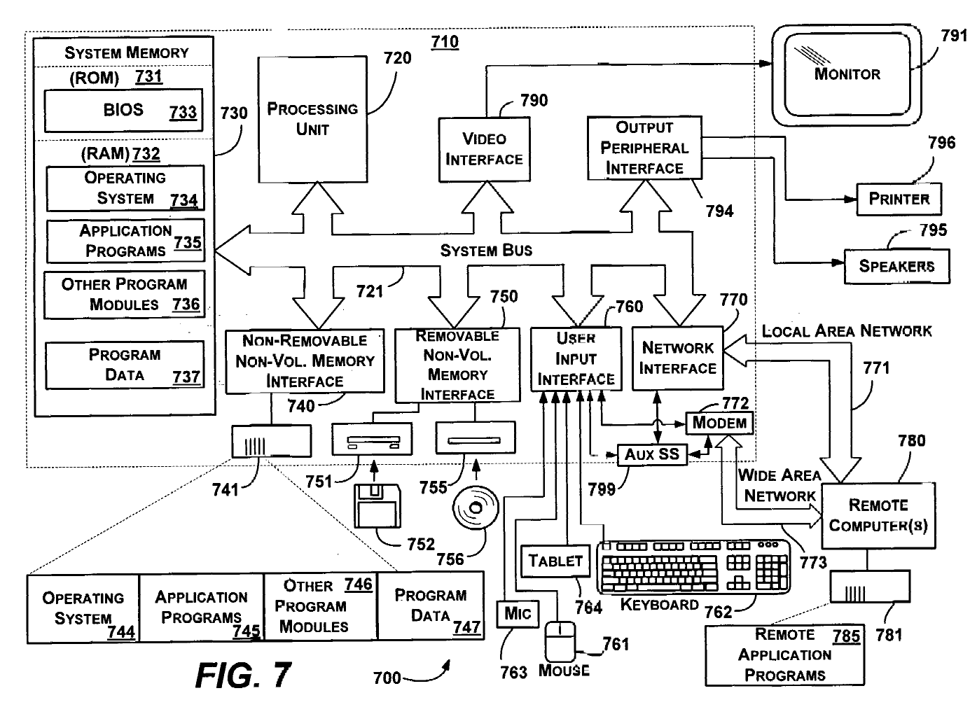

FIG. 7 illustrates an example of a suitable computing system environment 700 on which the dynamic program support links mechanism 108 (FIG. 2) may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one ore more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable media having computer-executable instructions, which when executed perform steps, comprising:
performing a search for content related to support of a program, in which the search is automatically generated based on a task of that program; and
aggregating results of the search for output in relation to the program.

2. The computer-readable media of claim 1 wherein performing the search comprises using a task name to generate a query.

3. The computer-readable media of claim 1 wherein performing the search comprises using active context data of the task to generate a query.

4. The computer-readable media of claim 3 wherein using the active context data comprises including information in the query that corresponds to error data.

5. The computer-readable media of claim 1 wherein performing the search comprises searching at least one site based on user preference data.

6. The computer-readable media of claim 1 wherein aggregating the results includes, for at least one result, outputting content or a link, or both content and a link, and a source.

7. The computer-readable media of claim 1 wherein aggregating the results includes ranking, grouping or filtering the results, or any combination of ranking, grouping or filtering the results.

8. The computer-readable media of claim 1 having further computer-executable instructions comprising, receiving effectiveness rating data corresponding to the results of the search, and maintaining user preference data including information corresponding to the effectiveness rating data.

9. The computer-readable media of claim 1 having further computer-executable instructions comprising, maintaining a user profile associated with the user that includes user preference data and rating data for use in constructing a search or filtering search results, or both.

10. In a computing environment, a system comprising:
a search system that receives input related to a program task;
a query generator coupled to the search system that generates at least one query based on the input and searches for results via the at least one query; and
an aggregator that aggregates the results for output in relation to the program.

11. The system of claim 10 further comprising a task engine that provides context data corresponding to at least some of the input related to the program task.

12. The system of claim 10 further comprising a data store that maintains historical or statistical data, or both, corresponding to at least some of the input related to the program task.

13. The system of claim 10 wherein the query generator generates at least one query based upon user preference data corresponding to a site to be searched.

14. The system of claim 10 further comprising a user interface, including means for providing the input related to a program task, and means for outputting the results.

15. The system of claim 10 wherein at least some of the input related to the program task comprises active context data, user preference data, error data, historical or statistical data, or explicit user input data, or any combination of active context data, user preference data, error data, historical or statistical data, and explicit user input data.

16. The system of claim 10 wherein the aggregator that aggregates the results for output ranks, groups or filters the results, or performs any combination of ranking, grouping or filtering the results.

17. In a computing environment, a method comprising:
generating a query related to a task, based upon a current context of the task; and
searching for content via the query, including searching at least one site based upon user preference data that indicates where to search for the content.

18. The method of claim 17 further comprising aggregating results obtained from the search for output.

19. A computer-readable medium having computer-executable instructions, which when executed perform the method of claim 17.
